(19) United States
(12) Patent Application Publication
(10) Pub. No.: US 2007/0070048 A1
(43) Pub. Date: Mar. 29, 2007

(54) Method and apparatus for controlling input devices in computer system with tablet device

(75) Inventor: Tatsuya Aoyagi, Tachikawa-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/521,770

(22) Filed: Sep. 15, 2006

(30) Foreign Application Priority Data
Sep. 29, 2005 (JP) 2005-284078

(51) Int. Cl. G09G 5/00

(52) U.S. Cl. 345/173

(57) ABSTRACT

According to one embodiment, a tablet device has a detector which detects whether the tablet device is in an available state or an unavailable state. An input device such as a keyboard and a touch pad inputs data in accordance with a user's input operation. A control unit makes the input device unavailable when the detector detects that the tablet device is in an available state, and makes the input device available when the detector detects that the tablet device is in an unavailable state.

### CROSS-REFERENCE TO RELATED APPLICATIONS

This application is based upon and claims the benefit of priority from Japanese Patent Application No. 2005-284078, filed Sep. 29, 2005, the entire contents of which are incorporated herein by reference.

### BACKGROUND

1. Field

On embodiment of the invention relates to a computer system provided with a tablet device in addition to an input device such as a keyboard, for example, controlling of the input device, which is carried out in accordance with the operation state of the tablet device.

2. Description of the Related Art

In recent years, computer systems have been developed which have a tablet device (digitizer) capable of detecting a coordinate value of a point indicated in position by a pointing device, e.g., a pen. In general, such a computer system includes, for example, a liquid crystal display at a surface of its housing. The tablet device is provided on a front surface or rear surface of the liquid crystal display. Due to this structure, the user can directly indicate a desired item in a menu or the like displayed on the display by using the pen. Furthermore, in such a computer system, preferably, the tablet device and an input device are selectively used in accordance with an intent of the user. Thus, generally, computer systems provided with a tablet device, for example, notebook computers, have an input device such as a keyboard.

In the notebook computers, the keyboard is located close to the screen. Thus, when the user uses the tablet device with a pen to input data (tablet-input operation), as is often the case with, he or she presses a key in the keyboard by mistake. That is, there is a likelihood that undesired input may be entered by mistake.

In view of the above, a following computer system has been provided. When the pen is not located in a pen holder, it is determined that the pen is to be used for input operation (tablet-input operation), and the keyboard is thus made unavailable for input operation, and when the pen is located in the pen holder, it is determined that it is not to be used for input operation, and the keyboard is thus made available for input operation (see Jpn. Pat. Appln. KOKAI Publication No. 7-72961).

Furthermore, in another proposed computer system, when the pen is removed from the pen holder, it is determined that the pen is to be used for input operation (tablet-input operation), and it is made available for input operation, and when the pen is inserted into the pen holder, it is determined that the pen is not to be used for input operation, and the keyboard is to be used for input operation, and thus the keyboard is made available for input operation (see Jpn. Pat. Appln. KOKAI Publication No. 8-255044).

In such a manner, in the above techniques, it is determined whether to make the keyboard available or unavailable for input operation (keyboard-input operation), in accordance with whether the pen is located in the pen holder or not. This structural feature can prevent the keyboard-input operation from being performed even when the user presses a key in the keyboard by mistake.

In the above techniques, when data is input by the tablet device, there is a case where the keyboard needs to be temporarily used to input data. However, in the above techniques, the keyboard is made unavailable when the pen is removed from the pen holder in order that the pen be used for tablet-input operation. Therefore, in order for the user to temporarily use the keyboard for keyboard-input operation, the user must return the pen to the pen holder. Such an operation is inconvenient for the user. In addition, when the pen is placed in a position other than the pen holder, the keyboard is kept unavailable. That is, in this case, the tablet-input operation is not performed; nonetheless, the keyboard-input operation cannot be performed. This is also inconvenient for the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of a computer 10 according to an embodiment of the present invention.

FIG. 2 is an exemplary view showing the system configuration of the computer 10 shown in FIG. 1.

FIG. 3 is an exemplary view showing a relationship between a tablet device 171, an embedded controller/keyboard controller (EC/KBC) 124 and an operating system (OS) 203 in the computer 10 according to the embodiment.

FIG. 4 is an exemplary flowchart of the procedure of processing for making a keyboard 13 and a touch pad 16 available/unavailable, which is applied in the embodiment.

FIG. 5 is an exemplary view showing a relationship between the tablet device 171, the EC/KBC 124, the OS 203, a filter driver 204 and a tablet driver 205, which are provided in the computer shown in FIG. 1, in a first modification of the embodiment.

FIG. 6 is an exemplary flowchart of the procedure of processing for making the keyboard 13 and the touch pad 16 available/unavailable in the first modification.

FIG. 7 is an exemplary view showing a relationship between the tablet device 171, the EC/KBC 124, the OS 203, the filter driver 204 and the tablet driver 205 in a second modification of the embodiment.

FIG. 8 is an exemplary view showing that in the second modification, each of an input surface 171a of the tablet device 171 and an input device area 150 are divided into a plurality of areas in management of the input surface 171a and the input device area 150.

FIG. 9 is an exemplary flowchart of the procedure of processing for making part of the keyboard 13 and the touch pad 16 available/unavailable in the second modification.

### DETAILED DESCRIPTION

Various embodiments according to the invention will be described hereinafter with reference to the accompanying drawings. In general, according to one embodiment of the invention, a computer system comprises: a tablet device having a detector which detects whether the tablet device is in an available state or an unavailable state; an input device configured to input data in accordance with a user's input operation; and a control unit configured to make the input device unavailable when the detector detects that the tablet device is in the available state, and make the input device available when the detector detects that the tablet device is in the unavailable state.

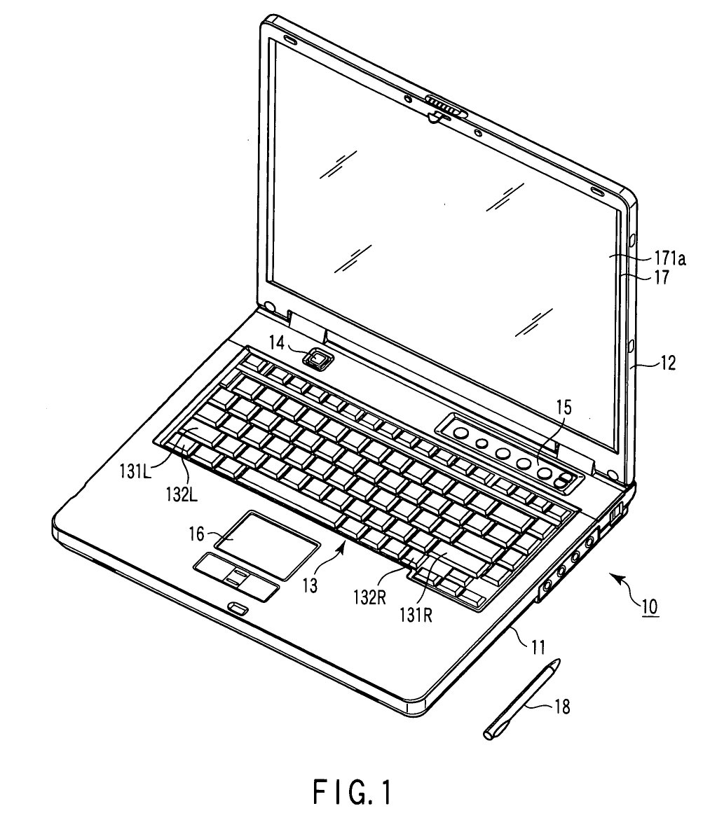

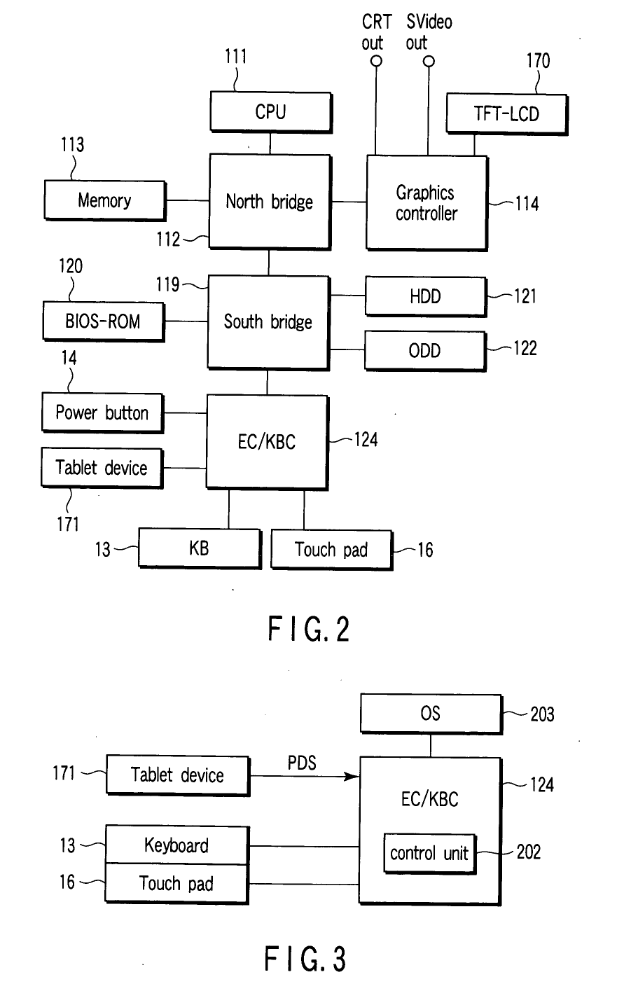

First of all, a computer system according to an embodiment of the present invention will be explained with reference to FIGS. 1 and 2. In the embodiment, a notebook computer 10 is described as the computer system.

FIG. 1 is a perspective view of the notebook computer 10, and shows a state in which a display unit of the notebook computer 10 is opened. To be more specific, the computer 10 comprises a computer body 11 and a display unit 12. The display unit 12 incorporates an LCD (display device) 17 provided with a tablet device. The LCD 17 comprises, e.g., a Thin Film Transistor Liquid Crystal Display (TFT-LCD) 170 and the tablet device (digitizer) 171 as shown in FIG. 2. The screen of the TFT-LCD 170 is located in substantially the center of the display unit 12. An input surface 171a of the tablet device 171 is located, e.g., in the front of the TFT-LCD 170. In this case, a surface of the LCD 17 serves as the input surface (coordinate input surface) 171a of the tablet device 171. The input surface 171a of the tablet device 171 may be located on a rear surface of the TFT-LCD 170. Furthermore, a pen 18 is used for giving a position instruction indicating a position with respect to the input surface 171a of the tablet device 171.

The display unit 12 is attached to the computer body 11 in such a way as to be rotatable between an open position and a closed position. The computer body 11 includes a thin box-shaped housing. On an upper surface of the housing, a keyboard (KB) 13, a power button 14 for turning on/off the computer 10, an input operation panel 15 and a touch pad 16 are arranged. The KB 13 includes a shift key 131L and a control key 132L close to a left end thereof and a shift key 131R and a control key 132R close to a right end thereof.

The input operation panel 15 is an input device which comprises a plurality of buttons for starting a plurality of functions associated with a plurality of events, respectively. Those buttons include a TV start button and a DVD/CD start button.

Next, the system configuration of the computer 10 will be explained with reference to FIG. 2. The computer 10, as shown in FIG. 2, comprises a CPU 111, a North Bridge 112, a main memory 113, a graphics controller 114, a South Bridge 119, a BIOS-ROM 120, a hard disk drive (HDD) 121, an optical disk drive (ODD) 122, an embedded controller/keyboard controller IC (EC/KBC) 124, the TFT-LCD 170 and the tablet device 171, etc.

The CPU 111 is a processor for controlling the operation of the computer 10. The CPU 111 executes an operating system (OS) 203 (see FIG. 3) for managing allocation of a hardware resources and software resources, etc. and kinds of application programs such as animation reproduction application program. The OS 203 and the application programs are loaded from the HDD 121 into the main memory 113.

Also, the CPU 111 executes a system Basic Input Output System (BIOS) stored in the BIOS-ROM 120. The system BIOS is a program for controlling hardware.

The North Bridge 112 is a bridge device connecting a local bus of the CPU 111 and the South Bridge 119. The North Bridge 112 incorporates a memory controller for controlling access to the main memory 113. Also, the North Bridge 112 has a function of communicating with the graphics controller 114 via an Accelerated Graphics Port (AGP) bus or the like.

The graphics controller 114 is a display controller for controlling the TFT-LCD 170, which is used as a display monitor of the computer 10. The graphics controller 114 causes video data written to a video memory (VRAM) to be displayed as video on the LCD 170.

The South Bridge 119 controls a plurality of devices on a Low Pin Count (LPC) bus and a plurality of devices on a Peripheral Component Interconnect (PCI) bus. Also, the South Bridge 119 incorporates an Integrated Drive Electronics (IDE) controller for controlling the HDD 121 and the ODD 122. Furthermore, the South Bridge 119 has a function of controlling access to the BIOS-ROM 120.

The HDD 121 is a memory device for storing kinds of software and data. The ODD 123 is a drive unit for driving a storage medium such as a CD medium and a DVD medium storing video content.

The EC/KBC 124 is a one-chip microcomputer in which an embedded controller (EC) for power management and a keyboard controller for controlling the KB 13 and the touch pad 16 are provided integrally with each other. The EC/KBC 124 has a function of turning on/off the computer 10 when the power button 14 is pressed by the user.

The tablet device 171 detects a coordinate value indicating a position indicated by the pen 18 with respect to the input surface 171a shown in FIG. 1, i.e., the position of part of the input surface 171a which is indicated by the pen 18. The pen 18 is recognized as an object to be detected, which can indicate a position on the input surface 171a. To be more specific, the input surface 171a of the tablet device 171 corresponds to the screen of the LCD 17 provided with the tablet (TFT-LCD 170), and the user can thus directly indicate a desired item in a menu displayed on the screen by using the pen 18.

The tablet 171 adopts an electromagnetic induction method to detect a coordinate value indicating the position indicated by the pen 18 (the object which can indicate the position) with respect to the input surface 171a. For example, the tablet 171 adopting the electromagnetic induction method can detect the presence of the pen 18 simply when the pen 18 is located within a given range from the input surface 171a even if the pen 18 does not directly contact the input surface 171a, and at the same time can detect a coordinate value of the position indicated by the pen 18. That is, the tablet device 171 can detect a first state in which the pen 18 is located close to the input surface 171a. This means that the tablet device 171 detects a state other than the first state, i.e., a second state in which the pen 18 is not located within the given range from the input surface 171a. However, the tablet device 171 adopting the electromagnetic induction method does not detect the presence of a pen other than a specific pen like the pen 18. Thus, even if, for example, the user touches the input surface 171a by mistake with his or her fingertip, the tablet 171 does not detect a coordinate value indicating the position of part of the input surface 171a which the fingertip touches. It should be noted that the tablet device 171 may adopt a position detection method other than the electromagnetic induction, e.g., a capacitance method. In this case, the user's fingertip can be used instead of the pen 18 since the fingertip can be detected as the object which can indicate the position.

FIG. 3 shows a relationship between the tablet device 171, the EC/KBC 124 and the OS 203. The tablet device 171 outputs a pen detection signal (PDS) indicating whether or not the pen 18 is located within the given range from the input surface 171a of the tablet device 171. When detecting that the pen 18 is located within the given range from the input surface 171a (the first state), the tablet device 171 sets the pen detection signal (PDS) to, e.g., a high level (High) (first logic state). On the other hand, when detecting the pen 18 is not located within the given range from the input surface 171a (the second state), the tablet device 171 sets the pen detection signal (PDS) to a low level (Low) (second logic state).

The EC/KBC 124 includes a control unit 202 for performing a control for making, e.g., the KB 13 and the touch pad 16 available/unavailable. The control unit 202 receives the pen detection signal (PDS) output from the tablet device 171. Furthermore, the control unit 202 determines whether to make the KB 13 and the touch pad 16 available/unavailable in accordance with the level of the pen detection signal (PDS). Then, when making the KB 13 and the touch pad 16 available, the control unit 202 sends input from the KB 13 and the touch pad 16 to the OS 203.

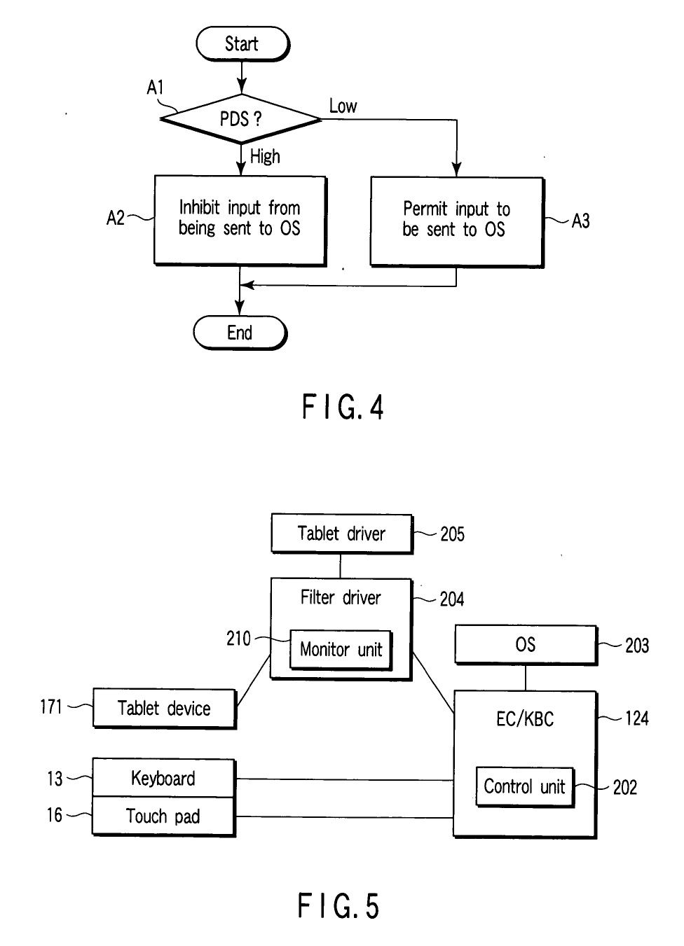

Next, the operation of the system according to the above embodiment will be explained with reference to the flowchart of FIG. 4 by way of the procedure of processing for making the KB 13 and the touch pad 16 available/unavailable. First, the control unit 202 determines whether the pen detection signal (PDS) is set at the high level (High) or the low level (Low) at Al. It should be noted that in the case where the tablet device 171 detects that the pen 18 is located close to the input surface 171a of the tablet device 171, i.e., it detects the presence of the pen 18, the pen detection signal (PDS) is set to the high level, and in the case where the pen 18 is not located within the given range from the input surface 171a, i.e., the tablet device 171 does not detect the presence of the pen 18, the pen detection signal (PDS) is set to the low level. Thus, when the pen detection signal (PDS) is set to the low level, it means that the tablet device 171 detects that the pen 18 is located away from the input surface 171a by a predetermined distance or more.

Determination on whether to make the KB 13 and the touch pad 16 available/unavailable can be seen from whether input from the KB 13 and the touch pad 16 is sent to the OS 203 or not.

When the pen detection signal (PDS) is set at the high level (at A1), the control unit 202 makes the KB 13 and the touch pad 16 unavailable at A2. To be more specific, it makes the KB 13 and the touch pad 16 unavailable by inhibiting the input from the KB 13 and the touch pad 16 from being sent to the OS 203. The non-availability of the KB 13 and the touch pad 16 is maintained until the pen detection signal (PDS) is changed from the high level to the low level. That is, the KB 13 and the touch pad 16 are not made available until the pen 18 is located away from the input surface 171a by the predetermined distance or more, i.e., it is located out of the given range from the input surface 171a.

On the other hand, when the pen detection signal (PDS) is set at the low level (at A1), the control unit 202 makes the KB 13 and the touch pad 16 available at A3. To be more specific, it makes the KB 13 and the touch pad 16 available by permitting the input from the KB 13 and the touch pad 16 to be sent to the OS 203.

The control unit 202 repeats the above processing, for instance, at regular intervals. As a result, if the pen detection signal (PDS) is changed to the low level i.e., the presence of the pen 18 becomes undetectable, when the KB 13 and the touch pad 16 are in the unavailable state, the KB 13 and the touch pad 16 are immediately made available. On the other hand, if the pen detection signal (PDS) is changed to the high level, i.e., the presence of the pen 18 is detected when the KB 13 and the touch pad 16 are in the available state, the KB 13 and the touch pad 16 are immediately made unavailable.

As explained above, according to the embodiment, when the user brings the pen 18 close to the input surface 171a of the tablet device 171 in order to perform the tablet-input operation, the tablet device 171 detects that the pen 18 is brought close to the input surface 171a. As a result, the KB 13 and the touch pad 16 are made unavailable by the control unit 202. By virtue of this structural feature, undesired input is prevented from being entered by mistake when the user presses a key in the KB 13 at a tablet-input operation time, i.e., the time of performing the tablet-input operation. Furthermore, in order to perform the keyboard-input operation or touch-pad-input operation, when the user temporarily moves the pen 18 away from the input surface 171a of the tablet device 171 to locate it out of the given range from the input surface 171a, the tablet device 171 detects that the pen 18 is located out of the given range from the input surface 171a. As a result, the KB 13 and the touch pad 16 are made available by the control unit 202, and the availability of the KB 13 and the touch pad 16 is maintained as long as the pen 18 is not located within the given range from the input surface 171a of the tablet device 171. The above structure enables the user to perform the keyboard-input operation or touch-pad-input operation simply by moving the pen 18 away from the input surface 171a of the tablet device 171 by the predetermined distance or more, and continuously perform the keyboard-input operation or touch-pad-input operation as long as the pen 18 is not located within the given range from the input surface 171a. Consequently, the operability of the system is improved.

[First Modification]

Next, a first modification of the above embodiment will be explained. FIG. 5 shows a relationship between the EC/KBC 124, the tablet device 171, the OS 203, a filter driver 204 and a tablet driver 205. With respect to the first modification, structural elements identical to those in FIG. 3 will be denoted by the same reference numerals as in FIG. 3, respectively, and their detail explanations will be omitted. Also, with respect to the other modifications which will be referred to later, the explanations given with respect to the above embodiment and first modification will not be repeated.

In the first modification, unlike the first embodiment, the tablet device 171 does not have a function of outputting the pen detection signal (PDS). The tablet driver 205 is a general-purpose driver for controlling (managing) the input and output operations of the tablet device 171, and is mounted in a computer provided with the tablet device 171. The tablet driver 205 has a function of detecting (reading) input from the tablet device 171 (e.g., a coordinate value of the position indicated by the pen 18).

However, in the first modification, it is necessary to detect (determine) whether the presence of the pen 18 is detected by the tablet device 171 or not based on the input from the tablet device 171, in order to make the KB 13 and the touch pad 16 available/unavailable. In other words, it is necessary to detect (determine) whether the pen 18 is located within the given range from the input surface 171a of the tablet device 171 or not based on the input from the tablet device 171.

Accordingly, in the first modification, the filter driver 204, which is controlled by the tablet driver 205, is provided between the tablet device 171 and the tablet driver 205. The filter driver 204 detects (reads) the coordinate value of the position indicated by the pen 18 from the input from the tablet device 171, and sends data indicating the coordinate value to the tablet driver 205. Furthermore, the filter driver 204 includes a monitor unit 210 for monitoring whether the presence of the pen 18 is detected by the tablet device 171 or not (i.e., the pen 18 is brought close to or away from the input surface 171a with respect to the given range) based on the input from the tablet device 171. To be more specific, the monitor unit 210 monitors whether the presence of the pen 18 is detected or not in accordance with whether the coordinate value of the indication value of the pen 18 is detected by the tablet device 171. In such a manner, the monitor unit 210 detects the state of the pen 18 based on the input from the tablet device 171. The monitor unit 210 informs the control unit 202 of the result of the above monitoring operation.

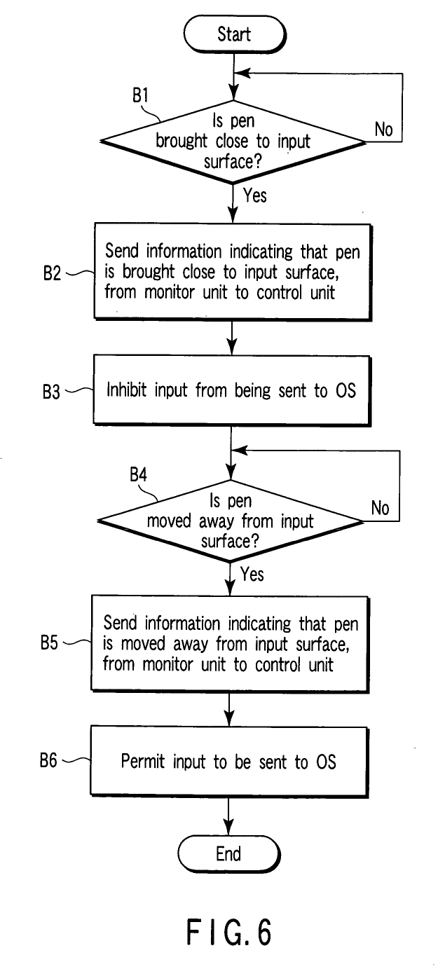

Next, the procedure of processing for making the KB 13 and the touch pad 16 available/unavailable in the first modification will be explained with reference to the flowchart of FIG. 6. The monitor unit 210 monitors (determines) whether or not the tablet device 171 detects that the pen 18 is brought close to the input surface 171a of the tablet device 171 at B1. The monitor unit 210 repeats the monitoring operation (determination) of B1 until the tablet device 171 detects that the pen 18 is brought close to the input surface 171a.

When the tablet device 171 detects that the pen 18 is brought close to the input surface 171a at B1, the monitor unit 210 informs the control unit 202 that the pen 18 is brought close to the input surface 171a at B2. As a result, the control unit 202 determines that the KB 13 and the touch pad 16 need to be made unavailable, and thus makes the KB 13 and the touch pad 16 unavailable at B3. To be more specific, it makes the KB 13 and the touch pad 16 unavailable by inhibiting the input from the KB 13 and the touch pad 16 from being sent to the OS 203 as in the above embodiment.

When the KB 13 and the touch pad 16 are made unavailable at B3, the monitor unit 210 re-monitors the state of the pen 18 based on the input from the tablet device 171. That is, the monitor unit 210 monitors (determines) whether or not the tablet device 171 detects that the pen 18 is moved away from the input surface 171a of the tablet device 171 at B4. The monitor unit 210 repeats the monitoring operation (determination) of B4 until that the tablet device 171 detects that the pen 18 is moved away from the input surface 171a.

When the tablet device 171 detects that the pen 18 is moved away from the input surface 171a, the monitor unit 210 informs the control unit 202 that the pen 18 is moved away from the input surface 171a at B5. As a result, the control unit 202 determines that the KB 13 and the touch pad 16 need to be made available, and thus makes the KB 13 and the touch pad 16 available at B6. To be more specific, the KB 13 and the touch pad 16 are made available by permitting the input from the KB 13 and the touch pad 16 to be sent to the OS 203 as in the first embodiment.

When the KB 13 and the touch pad 16 are made available at B6 after B5, the flow returns to B1, and the monitor unit 210 thus monitors (determines) whether or not the tablet device 171 detects that the pen 18 is brought close to the input surface 171a of the tablet device 171.

As explained above, in the first modification, the monitor unit 210 included in the filter driver 204 monitors the state of the pen 18 based on the input from the tablet device 171. Thus, although the tablet device 171 does not have a function of outputting the pen detection signal, the monitor unit 210 can detect that the pen 18 is brought close to the input surface 171a of the tablet device 171, when the pen 18 is done in order for the user to perform the table-input operation by using the pen 18. In accordance with the above detection, the control unit 202 makes the KB 13 and the touch pad 16 unavailable. Thus, undesired input is prevented from being entered when the user presses a key in the KB 13 by mistake at the tablet-input operation time. Accordingly, the operability of the system can be improved.

In the first modification, as explained above, the monitor unit 210 sends, to the control unit 202, information indicating that the pen 18 is brought close to or away form the input surface 171a of the tablet device 171. However, instead of this information, the monitor unit 210 may send, to the control unit 202, information requesting that the KB 13 and the touch pad 16 be made available/unavailable. Furthermore, the filter driver 204 may be incorporated into the tablet driver 205.

[Second modification]

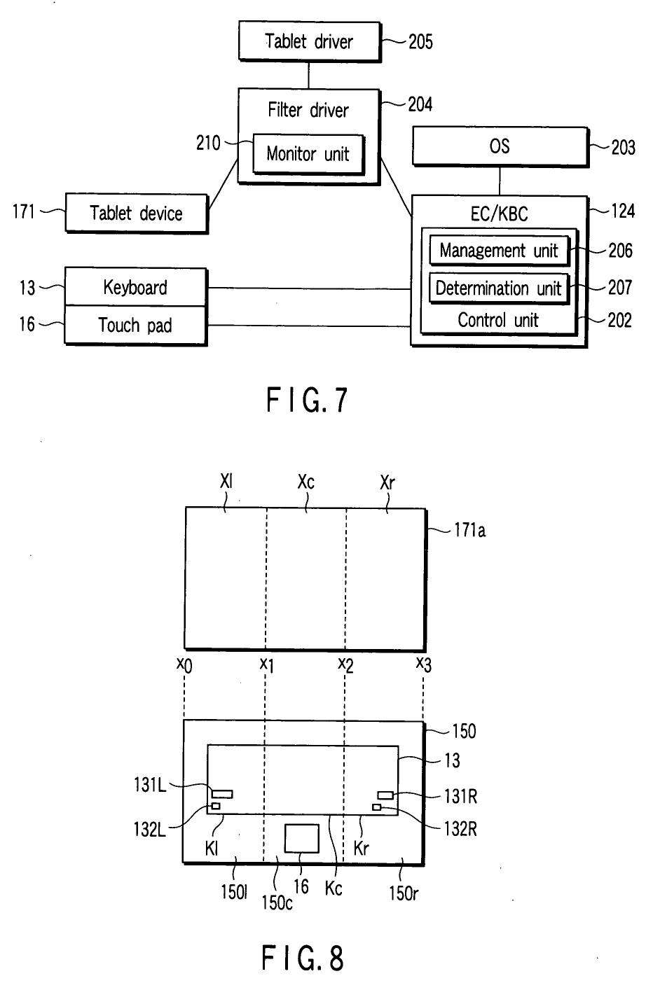

A second modification of the embodiment will be explained. FIG. 7 shows a relationship between the EC/KBC 124, the tablet device 171, the OS 203, the filter driver 204 and the tablet driver 205 in the second modification. A feature of the second modification resides in that only part of the KB 13 and the touch pad 16 are made unavailable based on the coordinate value (horizontal coordinate value x) of the position indicated by the pen 18, which the tablet device 171 obtains when detecting that the pen 18 is brought close to the input surface 171a. In order to achieve this, the monitor unit 210 included in the filter driver 204, unlike the first modification, has a function of detecting (reading) the horizontal coordinate value x of the position indicated by the pen 18 from the input from the touch pad 16, and informing the control unit 202 of the coordinate value x. The control unit 202 makes only part of the KB 13 and the touch pad 16 unavailable based on the coordinate value x. In order to do so, the control unit 202 includes a management unit 206 and a determination unit 207.

In order to manage the input surface 171a of the tablet device 171 and an input device area in which an input device including the KB 13 and the touch pad 16 is provided, the management unit 206 divides each of the input surface 171a and the input device area into a plurality of areas. This management of the management unit 206 will be explained in detail with reference to FIG. 8.

As shown in FIG. 8, the input device including the KB 13 and the touch pad 16 is provided in an input device area 150. Suppose a horizontal coordinate range of the input device area 150 is substantially equivalent to that of the input surface 171a of the tablet device 171. In order to manage the input surface 171a, the management unit 206 divides the input surface 17 into a plurality of areas, e.g., three areas Xl, Xc and Xr as shown in FIG. 8, in the horizontal direction (x axis). The horizontal coordinate ranges of the areas Xl, Xc and Xr are set as the range of x0 to x1, that of x1 to x2 and that of x2 to x3, respectively.

Similarly, in order to manage the input device area 150, the management unit 206 divides the input device area 150 into a plurality of areas the number of which is equal to that of the above areas of the input surface 171a, e.g., areas 150l, 150c and 150r which are respectively associated with the areas Xl, Xc and Xr of the input surface 171a. In an example shown in FIG. 8, the horizontal coordinate values of the boundaries between the areas 150l, 150c and 150r are equal to those of the boundaries between the areas Xl, Xc and Xr.

The KB 13 is provided in such a manner as to extend over the areas 150l, 150c and 150r. Suppose key groups of the KB 13 comprise a first key group Kl, a second key group Kc and a third key group Kr, which are located in the areas 150l, 150c and 150r, respectively. The key group Kl located in the area 150l (second area) includes control keys such as the shift key 131L and the control key 132L. The key group Kr located in the 150r (third area) includes control keys such as the shift key 131R and the control key 132R. The touch pad 16 is located in, e.g., the area 150c (first area) which is the center one of the areas 150l, 150c and 150r.

Re-referring to FIG. 7, the determination unit 207 determines which of the areas Xl, Xc and Xr of the input surface 171a of the tablet device 171, which are managed by the management unit 206, is associated with the horizontal coordinate value x of the position indicated by the pen 18, of which the monitor unit 210 informs the control unit 202. Furthermore, the determination unit 207 specifies which of the areas 150l, 150c and 150r of the input device area 150 managed by the management unit 206 is associated with the area of the input area 171a which is determined to be associated with the horizontal coordinate value x. The control unit 202 makes unavailable only part of the input device, which corresponds to the above specified area of the input device area 150, for example, part of the input device, which is located in the specified area of the input device area 150.

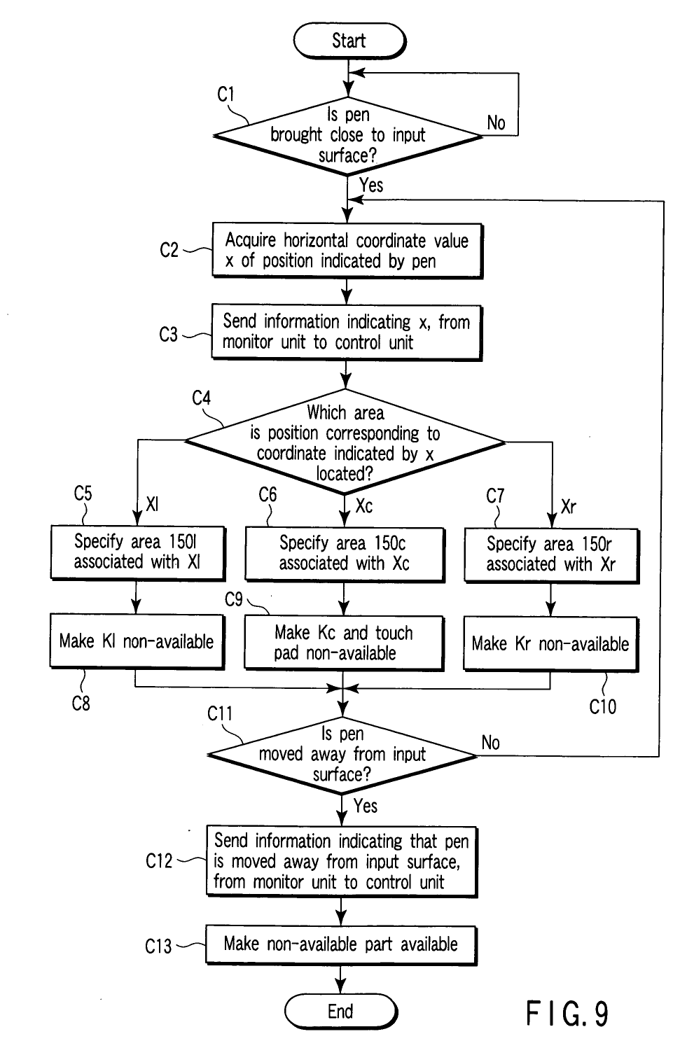

Next, the procedure of processing for making part of the KB 13 and the touch pad 16 available/unavailable will be explained with reference to the flowchart of FIG. 9. The monitor unit 210 monitors whether the tablet device 171 detects that the pen 18 is brought close to the input surface 171a of the tablet device 171, based on the input from the tablet device 171 at C1. In this case, the monitor unit 210 monitors (detects) whether the pen 18 is brought close to the input surface 171a, in accordance with whether the tablet device 171 detects the coordinate value of the position indicated by the pen 18.

When the tablet device 171 detects that the pen 18 is brought close to the input surface 171a, the monitor unit 210 acquires the horizontal coordinate value x of the position indicated by the pen 18, from the input from the tablet device 171 at C2. The monitor unit 210 informs the control unit 202 of the coordinate value x at C3.

The determination unit 207 of the control unit 202 determines one of the horizontal coordinate ranges of the areas Xl, Xc and Xr of the input surface 171a of the tablet device 171, as a horizontal coordinate range in which a coordinate indicated by the horizontal coordinate value x is located at C4. When the coordinate indicted by the coordinate value x is located in the area Xl, the determination unit 207 specifies the area 150l associated with the area Xl, of the areas 150l, 150c and 150r of the input device area 150 at C5. Similarly, when the coordinate indicated by the coordinate value x is located in the area Xc, the determination unit 207 specifies the area 150c associated with the area Xc at C6, and when the coordinate indicated by the coordinate value x is located in the area Xr, the determination unit 207 specifies the area 150r associated with the area Xr at C7.

When the area 150l is specified, the control unit 202 makes unavailable part of the input device which is located in the area 150l, i.e., the key group Kl of the KB 13 at C8. Although this processing is different from that in the first modification with respect to whether the input device is entirely or partially made unavailable, it is achieved in the same manner as in the first modification.

It should be noted that when the user indicates a position in the area Xl of the input surface 171a of the tablet device 171 by using the pen 18, there is a high possibility that elements of the input device which are located in the area 150l of the input device area 150, i.e., a key or keys of the key group Kl of the KB 13, are pressed by, e.g., the user's arm, as compared with the other elements of the input device, which are located in the areas 150c and 150r. Therefore, after the key group Kl is made unavailable, even if a key or keys in the key group Kl are pressed by mistake when the tablet-input operation is performed to indicate a position in the area Xl of the input area 171a, undesired input can be prevented from being entered.

Furthermore, in the second modification, in the above case, those elements of the input device which are located in the areas other than the area 150l of the input device area 150, i.e., the key groups Kc and Kr of the KB 13 and the touch pad 16, are not made unavailable. Thus, the user can operate keys of the key groups Kc and Kr (key-input operation) and the touch pad 16 even when the tablet-input operation is performed, i.e., even at the tablet-input operation time. In particular, it should be noted that the key group Kr includes the shift key 131R and the control key 132R (control keys). Thus, in the second modification, even when the key group Kc is made unavailable, the shift key 131R and the control key 132R can be used at the tablet-input operation time. Therefore, the operability is improved.

Similarly, when the area 150c is specified, the control unit 202 makes unavailable part of the input device which is located in the area 150c, i.e., the key group Kc of the KB 13 and the touch pad 16 at C9. After the key group Kc and the touch pad 16 are made unavailable, even if the user presses a key or keys in the key group Kc or the touch pad 16 by mistake when the tablet input operation is performed to indicate a position in the area Xc of the input surface 171a by using the pen 18, undesired data is prevented from being input. Furthermore, in the second modification, those elements of the input device which are located in the areas other than the area 150c of the input device area 150, i.e., the key groups Kl and Kr of the KB 13, are not made unavailable. Thus, even when the tablet-input operation is performed, the user can use the shift key 131L and control key 132L included in the key group Kl or the shift key 131R and control key 132R included in the key group Kr.

Also, similarly, when the area 150r is specified, part of the input device which is located in the area 150r, i.e., the key group Kr of the KB 13, is made unavailable at C10. After the key group Kr is made unavailable, even if the user presses a key or keys in the key group Kr of the KB 13 by mistake when the tablet input operation is performed to indicate a position in the area Xr of the input surface 171a by using the pen 18, undesired input is prevented from being entered. Furthermore, in the second modification, those elements of the input device which are located in the areas other than the area 150r of the input device area 150, i.e., the Kl and Kc of the KB 13 and the touch pad 16, are not made unavailable. Thus, even when the tablet-input operation is performed, the user can operate the shift key 131L and control key 132L included in the key group Kl and the touch pad 16.

When the monitor unit 210 informs the control unit 202 of the coordinate value x in C3, and part of the input device is then made unavailable at C7, C8 or C9, the monitor unit 210 determines whether or not the tablet device 171 detects that the pen 18 is moved away from the input surface 171a of the tablet device 171, based on the input from the tablet device 171 at C11. When the pen 18 is not moved away from the input surface 171a, the flow returns to C2, and the monitor unit 210 acquires the horizontal coordinate value x of the position indicated by the pen 18 from the input from the tablet device 171. Then, the following processings are carried out in the same manner as stated above: Thereafter, when the pen 18 is moved away from the input surface 171a, and then in C11, when the monitor unit 210 detects that the tablet device 171 detects that the pen 18 is moved away from the input surface 171a, the monitor unit 210 sends to the control unit 202, information indicating that the pen 18 is moved away from the input surface 171a at C12. When receiving the information, the control unit 202 makes unavailable part of the input device available at C13. Although this processing of the control unit 202 is different from that in the first modification with respect to which part of the input device is made available, it can be carried out in the same manner as in the first modification. When the above information is sent to the control unit 202 in C12, and the unavailable part of the input device is made available at C13, the flow returns to C1, and the monitor unit 210 monitors whether the tablet device 171 detects that the pen 18 is brought close to the input surface 171a. That is, the above C1 to C13 are repeatedly carried out as long as the computer 10 is driven.

In the second modification, as described above, in order to manage the input surface 171a of the tablet device 171 and the input device area 150, each of the input surface 171a and the input device area 150 is divided into three areas. However, the number of areas to be set by the above division is not limited to three. For example, in the case where the touch pad 16 is not used for the tablet-input operation, the input surface 171a of the tablet device 171 may be divided into two areas, e.g., the area Xr and the other area which is a combination of the areas Xl and Xc, or the area Xl and the other area which is a combination of the areas Xr and Xc. In this case, the area 150c of the input device area 150 is combined with the area 150l or the area 150r such that this combination is associated with the combination of the areas Xl and Xc or that of the areas Xr and Xc. In this case also, at the tablet-input operation time, undesired input can be prevented from being entered by mistake, and the shift key 131L and the control key 132L or the shift key 131R and the control key 132R can be used. In addition, for example, the touch pad 16 may be excluded from the objects to be made available/unavailable. In this case, each of the input surface 171a and the input device area 150 may be divided in two substantially equal areas in order to manage them.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computer system comprising:
a tablet device having a detector which detects whether the tablet device is in an available state or an unavailable state;
an input device configured to input data in accordance with a user's input operation; and
a control unit configured to make the input device unavailable when the detector detects that the tablet device is in an available state, and make the input device available when the detector detects that the tablet device is in an unavailable state.

2. The computer system according to claim 1, wherein the tablet device includes an input surface, and the detector detects that the tablet device is in an available state when an object capable of indicating a position is brought close to the input surface, and that the tablet device is in an unavailable state when the object is moved away from the input surface.

3. The computer system according to claim 1, which further comprises a display, and wherein the tablet device is located at one of a front surface and a rear surface of the display.

4. The computer system according to claim 1, wherein:
the tablet device outputs a detection signal which is set to a first level when the available state is detected, and a second level when the unavailable state is detected; and
the control unit makes the input device available or unavailable based on the level of the detection signal.

5. The computer system according to claim 4, wherein the control unit informs an operating system of input from the input device, and inhibits the input from the input device from being sent to the operating system when the detection signal is in the first level.

6. The computer system according to claim 1, further comprising a monitor unit configured to monitor whether the detector detects that the tablet device is in the available state or that tablet device is in the unavailable state, and to inform the control unit of a result of detection by the detector, and wherein the control unit makes the input device available or unavailable in accordance with the result of the detection.

7. The computer system according to claim 6, wherein:
when informing the control unit that the tablet device is in the available state, the monitor unit informs the control unit of a horizontal coordinate value of a position indicated by an object, which is detected by the detector; and the control unit makes part of the input device unavailable based on the horizontal coordinate value of which the monitor unit informs the control unit.

8. The computer system according to claim 7, wherein the control unit includes:
a management unit configured to divide an input surface of the tablet device into a plurality of areas in a horizontal direction to manage the input surface, and also divide an input device area in which the input device is provided, into a plurality of areas the number of which is equal to that of the plurality of areas of the input surface of the tablet device, to manage the input device area, the plurality of areas of the input device area being associated with the plurality of areas of the input surface, respectively; and
a determination unit configured to determine one of the plurality of areas of the input surface as an area in which the position corresponding to the horizontal coordinate value is located, and specify one of the plurality of areas of the input device area, which is associated with the determined one of the plurality of areas of the input surface, and
wherein part of the input device, which corresponds to the specified one of the plurality of areas of the input device area, is made unavailable.

9. The computer system according to claim 8, wherein:
the input device includes a keyboard and a touch pad, the keyboard being located in part of the input device area, which corresponds to a horizontal coordinate range of the input surface of the tablet device, the touch pad being located in another part of the input device area, which corresponds to a center part of the horizontal coordinate range of the input surface of the tablet device;
the management unit divides each of the input surface and the input device area into first to third areas to manage the input surface and the input device area, the first area being located to correspond to the touch pad, and also being provided between the second and third areas;
the determination unit determines one of the first to third areas of the input surface as the area in which the position corresponding to the horizontal coordinate value is located, and specifies one of the first to third areas of the input device area, which is associated with the determined area of the first to third areas of the input area; and
the control unit makes unavailable the touch pad and part of the keyboard, which corresponds to the first area in the input device area, when the determination unit specifies the first area, and also makes unavailable another part of the keyboard, which corresponds to one of the second and third areas in the input device area, when the determination area specifies the one of the second and third areas.

10. The computer system according to claim 9, wherein the keyboard includes shift keys which are respectively located in the second and third areas of the input device area.

11. The computer system according to claim 9, wherein the keyboard includes control keys which are respectively located in the second and third areas of the input device areas.

12. The computer system according to claim 8, wherein:
the input device includes a keyboard located in part of the input device area, which corresponds to a horizontal coordinate range of the input surface of the tablet device;
the management unit divides each of the input surface and the input device area into first and second areas to manage the input surface and the input device area;
the determination unit determines one of the first and second areas of the input surface as the area in which the position corresponding to the horizontal coordinate value is located, and specifies one of the first and second areas of the input device area, which is associated with the determined one of the first and second areas of the input surface; and
the control unit makes unavailable part of the keyboard, which corresponds to the specified one of the first and second areas of the input device area.

13. The computer system according to claim 12, wherein the keyboard includes shift keys which are respectively located in the first and second areas of the input device area.

14. The computer system according to claim 12, wherein the keyboard includes control keys which are respectively located in the first and second areas of the input device area.

15. The computer system according to claim 12, wherein:
the input device further includes a touch pad which is located in one of the first and second areas of the input device area; and
the control unit makes unavailable the touch pad and part of the keyboard, which corresponds to the specified one of the first and second areas of the input device area, when the touch pad is located in the specified one of the first and second areas of the input device area.

16. A method of controlling an input operation of an input device in a computer system comprising a tablet device, the method comprising:
detecting whether the tablet device is in an available state or an unavailable state; and
making the input device unavailable when the tablet device is in the available state, and the input device available when the tablet device is in the unavailable state.
